(19) United States
(12) Patent Application Publication
(10) Pub. No.: US 2011/0212804 A1
(43) Pub. Date: Sep. 1, 2011

(54) CONTROL DEVICE FOR VEHICLE POWER TRANSMISSION DEVICE

(75) Inventors: Tatsuya Imamura, Okazaki-shi (JP); Atsushi Tabata, Okazaki-shi (JP); Keita Imai, Toyota-shi (JP); Tooru Matsubara, Toyota-shi (JP); Kenta Kumazaki, Toyota-shi (JP)

(73) Assignee: TOYOTA JIDOSHA KABUSHIKI KAISHA, Toyota-shi, Aichi-ken (JP)

(21) Appl. No.: 13/127,119

(22) PCT Filed: Nov. 20, 2008
(86) PCT No.: PCT/JP2008/071131

§ 371 Date: May 2, 2011

(51) Int. Cl. F16H 48/06

(52) U.S. Cl. 475/150

(57) ABSTRACT

A control device for a vehicle power transmission device includes: an electric differential portion having a differential mechanism that includes a first rotating element, a second rotating element that functions as an input rotating member coupled to an engine, and a third rotating element that functions as an output rotating member, a first electric motor coupled to the first rotating element, and a second electric motor connected to a power transmission path from the third rotating element to drive wheels in a manner enabling power transmission, the electric differential portion controlling a differential state between a rotation speed of the second rotating element and a rotation speed of the third rotating element by controlling an operation state of the first electric motor, the control device executing inertia torque compensation control that drives the first electrode motor to generate a compensation torque for reducing an inertia torque generated in the first electric motor in association with a change in rotation speed of the second electric motor at the time of acceleration of a vehicle, and the inertia torque compensation control being executed at the start of a vehicle.

### TECHNICAL FIELD

The present invention relates to a control device for a hybrid vehicle power transmission device including an electric differential portion, and more particularly, to improvement for suppressing a decrease in acceleration during accelerating of a vehicle.

### BACKGROUND ART

It is known a control device for a vehicle power transmission device comprising: an electric differential portion having a differential mechanism that includes a first rotating element, a second rotating element that functions as an input rotating member coupled to an engine, and a third rotating element that functions as an output rotating member, a first electric motor coupled to the first rotating element, and a second electric motor connected to a power transmission path from the third rotating element to drive wheels in a manner enabling power transmission, the electric differential portion controlling a differential state between a rotation speed of the second rotating element and a rotation speed of the third rotating element by controlling an operation state of the first electric motor. This corresponds to a control device for a vehicle driving device described in Patent Document 1, for example. In this technique, the rotation speed control of the engine is performed by controlling the operation state of the first electric motor as needed so as not to change the engine rotation speed during a shift by a mechanical shifting portion, for example.
Patent Document 1: Japanese Laid-Open Patent Publication No. 2007-118696

### DISCLOSURE OF THE INVENTION

### Problem to Be Solved by the Invention

However, the inventors have newly found a problem that if acceleration is caused by using a power output from the second electric motor included in the electric differential portion in the conventional technique described above, the rotary inertia of the first electric motor is accelerated or decelerated in association with a change in the rotation speed of the second electric motor and, therefore, a portion of the power output from the second electric motor is used as an inertia torque (inertia moment) generated in the first electric motor, decreasing the vehicle acceleration.

The present invention was conceived in view of the situations and it is therefore an object of the present invention to provide a control device that suppresses a decrease in acceleration of a vehicle power transmission device including an electric differential portion at the time of acceleration of a vehicle.

### Means for Solving the Problem

The object indicated above can be achieved according to a first mode of the present invention, which provides a control device for a vehicle power transmission device comprising: an electric differential portion having a differential mechanism that includes a first rotating element, a second rotating element that functions as an input rotating member coupled to an engine, and a third rotating element that functions as an output rotating member, a first electric motor coupled to the first rotating element, and a second electric motor connected to a power transmission path from the third rotating element to drive wheels in a manner enabling power transmission, the electric differential portion controlling a differential state between a rotation speed of the second rotating element and a rotation speed of the third rotating element by controlling an operation state of the first electric motor, the control device executing inertia torque compensation control that drives the first electrode motor to generate a compensation torque for reducing an inertia torque generated in the first electric motor in association with a change in rotation speed of the second electric motor at the time of acceleration of a vehicle.

### Effect of the Invention

Since the control device executing inertia torque compensation control drives the first electrode motor to generate a compensation torque for reducing an inertia torque generated in the first electric motor in association with a change in rotation speed of the second electric motor at the time of acceleration of a vehicle, the reduction of the power output from the second electric motor can be suppressed to ensure sufficient acceleration performance. Therefore, the control device can be provided that suppresses a decrease in acceleration of the vehicle power transmission device including the electric differential portion at the time of acceleration of a vehicle.

Preferably, if a rotation speed of the engine is equal to or greater than a predetermined threshold value, an absolute value of the compensation torque generated in the inertia torque compensation control is reduced as compared to the case of less than the threshold value. This can preferably restrain the rotation speed of the engine from increasing more than necessary.

Preferably, the inertia torque compensation control is executed if a slope of a road surface on which a vehicle travels is inclined at a predetermined angle defined in advance or greater. This can ensure sufficient acceleration performance at the time of traveling on a slope road particularly requiring the acceleration performance.

Preferably, the inertia torque compensation control is executed if a vehicle mass is equal to or greater than a predetermined value defined in advance. This can ensure sufficient acceleration performance in the case of a relatively heavy vehicle weight particularly requiring the acceleration performance.

Preferably, the inertia torque compensation control is executed if an accelerator opening degree is equal to or greater than a predetermined value defined in advance. This can ensure sufficient acceleration performance at the time of a driver's accelerating operation (when pressing the accelerator pedal) particularly requiring the acceleration performance.

Preferably, the inertia torque compensation control is executed at the start of a vehicle. This can ensure sufficient acceleration performance at the start of the vehicle particularly requiring the acceleration performance.

Preferably, the control device for a vehicle power transmission device includes a mechanical shifting portion disposed at a portion of the power transmission path between the differential portion and the drive wheels and having an input member coupled to the second electric motor, wherein the inertia torque compensation control is executed in accordance with a change in rotation speed of the second electric motor associated with shift of the mechanical shifting portion. This can ensure sufficient acceleration performance at the time of the shift of the mechanical shifting portion.

### BRIEF DESCRIPTION OF DRAWINGS

FIG. 1 is a schematic for explaining an example of a configuration of a power transmission device of a hybrid vehicle to which the present invention is preferably applied.

FIG. 2 is a collinear diagram capable of representing, on straight lines, the relative relationships of the rotation speeds of the three rotating elements included in the planetary gear device with regard to the differential portion provided in the power transmission device in FIG. 1.

FIG. 3 is a schematic for explaining another example of a configuration of a power transmission device of a hybrid vehicle to which the present invention is preferably applied

FIG. 4 is a collinear diagram capable of representing, on straight lines, the relative relationships of the rotation speeds of the four rotating elements provided in the planetary gear device with regard to the differential portion provided in the power transmission device in FIG. 3.

FIG. 5 is a diagram for exemplarily illustrating signals input to an electronic control device for controlling the power transmission devices in FIGS. 1 to 3 and signals output from the electronic control device.

FIG. 6 is a diagram of an example of a shift operation device as a switching device that switches a plurality of types of shift positions P_{SH} through artificial operation in the power transmission devices in FIGS. 1 to 3.

FIG. 7 is a functional block diagram for explaining a main portion of the control function equipped in the electronic control device in FIG. 5.

FIG. 8 is a time chart of an example of changes with time in torque and rotation speed of each of the engine, the first electric motor and the second electric motor of the power transmission device depicted in FIG. 1 at the time of acceleration of a vehicle, corresponding to the control in a conventional technique.

FIG. 9 is a collinear diagram for explaining changes in rotation speeds of the rotating elements in the differential portion of the power transmission device in FIG. 1, corresponding to the time chart depicted in FIG. 8

FIG. 10 is a time chart of an example of changes with time in torque and rotation speed of each of the engine, the first electric motor, and the second electric motor of the power transmission device depicted in FIG. 1 at the time of acceleration of a vehicle, corresponding to the control of this embodiment.

FIG. 11 is a collinear diagram for explaining changes in rotation speeds of the rotating elements in the differential portion of the power transmission device in FIG. 1, corresponding to the time chart depicted in FIG. 10, and, particularly, it shows the direction of the compensation torque generated in the first electric motor.

FIG. 12 is a time chart of an example of changes with time in torque and rotation speed of each of the engine, the first electric motor, and the second electric motor of the power transmission device depicted in FIG. 3 at the time of acceleration of a vehicle, corresponding to the control in a conventional technique.

FIG. 13 is a collinear diagram for explaining changes in rotation speeds of the rotating elements in the differential portion of the power transmission device in FIG. 3, corresponding to the time chart depicted in FIG. 12.

FIG. 14 is a time chart of an example of changes with time in torque and rotation speed of each of the engine, the first electric motor, and the second electric motor of the power transmission device depicted in FIG. 3 at the time of acceleration of a vehicle, corresponding to the control of this embodiment.

FIG. 15 is a collinear diagram for explaining changes in rotation speeds of the rotating elements in the differential portion of the power transmission device in FIG. 3, corresponding to the time chart depicted in FIG. 14, and, particularly, it shows the direction of the compensation torque generated in the first electric motor.

FIG. 16 is a time chart, on starting of the vehicle in EV traveling mode, of an example of changes with time in torque and rotation speed of each of the engine, the first electric motor, and the second electric motor of the power transmission device depicted in FIG. 1 at the time of acceleration of a vehicle, corresponding to the control in a conventional technique.

FIG. 17 is a collinear diagram for explaining changes in rotation speeds of the rotating elements in the differential portion of the power transmission device in FIG. 1, corresponding to the time chart depicted in FIG. 16

FIG. 18 is a time chart, on starting of the vehicle in EV traveling mode, of an example of changes with time in torque and rotation speed of each of the engine, the first electric motor, and the second electric motor of the power transmission device depicted in FIG. 1 at the time of acceleration of a vehicle, corresponding to the control of this embodiment.

FIG. 19 is a collinear diagram for explaining changes in rotation speeds of the rotating elements in the differential portion of the power transmission device in FIG. 1, corresponding to the time chart depicted in FIG. 18, and, particularly, it shows the direction of the compensation torque generated in the first electric motor.

FIG. 20 is a flowchart for explaining a main portion of an example of the inertia torque compensation control by the electronic control device in FIG. 5.

FIG. 21 is a flowchart for explaining a main portion of another example of the inertia torque compensation control by the electronic control device in FIG. 5.

FIG. 22 is a flowchart for explaining a main portion of further example of the inertia torque compensation control by the electronic control device in FIG. 5.

### EXPLANATIONS OF LETTERS OR NUMERALS

10,30: Power transmission device for vehicle, 12: Engine, 14: Transmission case, 16: Input shaft, 18, 34: Differential portion, 20: Transmitting member (Power transmission shaft), 22: Automatic shifting portion, 24: Output shaft, 26: Planetary gear device (Differential mechanism), 32: Input shaft, 36: Output gear, 38: First planetary gear device (Differential mechanism), 40: Second planetary gear device (Differential mechanism), 42: Differential gear device, 44: Drive wheels, 46: Shift operation device, 48: Shift lever, 50: Electronic control device, 52: Engine rotation speed sensor, 54: Vehicle speed sensor, 56: Accelerator opening degree sensor, 58: Vehicle acceleration sensor, 60: Vehicle weight sensor, 62: Engine output control device, 64: Inverter, 66: Electric storage device, 70: Hybrid control portion, 72: Inertia torque compensation control portion, 74: Engine rotation speed determining portion, 76: Road surface slope determining portion, 78: Vehicle mass determining portion, 80: Accelerator opening degree determining portion, 82: Vehicle start determining portion, CA: Carrier (Second rotating element), CA1, CA2: Carrier, M1: First electric motor, M2: Second electric motor, P, P1, P2: Pinion gear, R: Ring gear (Third rotating element), R1, R2: Ring gear, RE1: First rotating element, RE2: Second rotating element, RE3: Third rotating element, RE4: Fourth rotating element, S: Sun gear (First rotating element), S1, S2: Sun gear

### BEST MODES FOR CARRYING OUT THE INVENTION

Embodiments of the present invention will now be described in detail with reference to the drawings.

### Embodiments

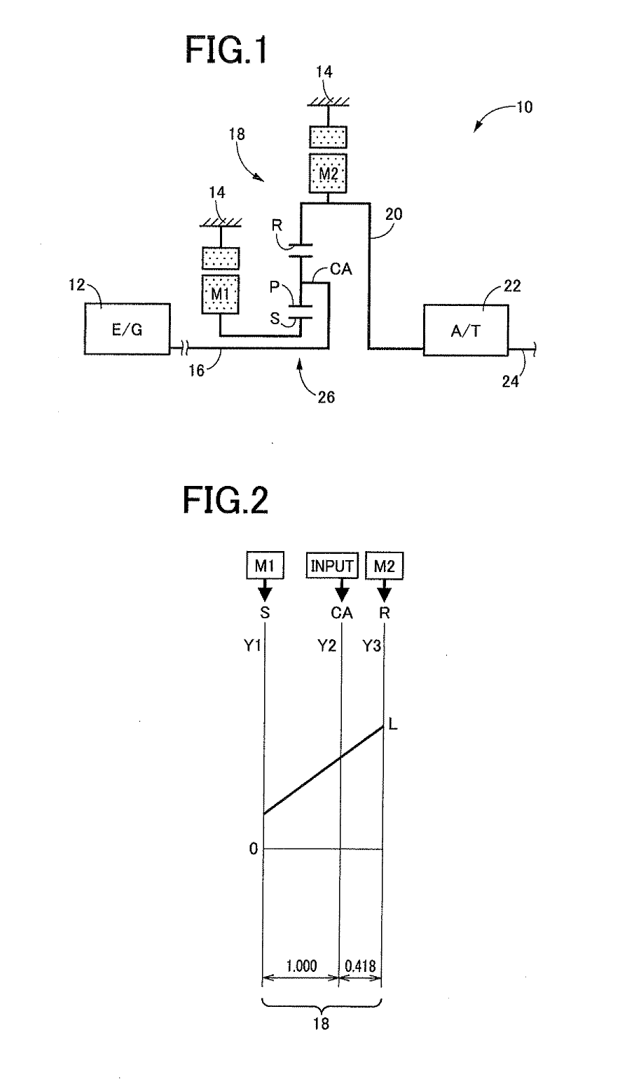

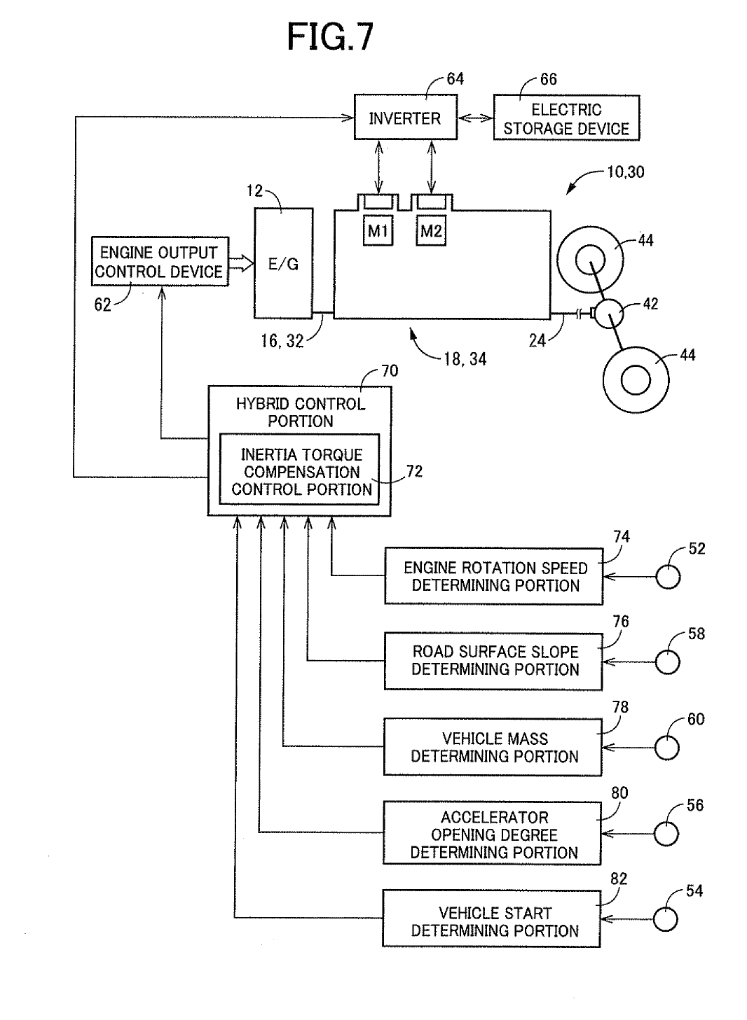

FIG. 1 is a schematic for explaining an example of a configuration of a power transmission device of a hybrid vehicle to which the present invention is preferably applied. A power transmission device 10 depicted in FIG. 1 is preferably used as a mechanism for transmitting power output from an engine 12 that is a drive power source to drive wheels 44 (see FIG. 7) for, for example, an FR (front-engine rear-drive) type vehicle with the power transmission device 10 longitudinally placed in the vehicle. And the power transmission device 10 includes, in series, an input shaft 16 coupled to an output shaft (crankshaft) of the engine 12; a differential portion 18 coupled to the input shaft 16 directly or indirectly via a pulsation absorbing damper (pulsation damping device) not depicted or the like; an automatic shifting portion (automatic transmission portion) 22 serially coupled via a transmitting member (power transmission shaft) 20 on a power transmission path between the differential portion 18 and the drive wheels 44; and an output shaft 24 coupled to the automatic shifting portion 22, which are disposed on a common shaft center in a transmission case 14 (hereinafter, a case 14) that is a non-rotating member attached to a vehicle body.

The engine 12 is an internal-combustion engine, for example, a gasoline engine or a diesel engine that generates power through combustion of liquid fuel, and the power transmission apparatus 10 is disposed on the power transmission path between the engine 12 and a pair of the drive wheels 44 to transmit the power from the engine 12 to the pair of the drive wheels 44 sequentially through a differential gear device (final reduction gear) 42 (see FIG. 7) and a pair of axles etc. In the power transmission device 10 depicted in FIG. 1, the engine 12 is directly coupled to the differential portion 18. This direct coupling portion that the coupling is achieved without the intervention of a fluid type power transmission device such as a torque converter or a fluid coupling and this coupling includes, for example, a coupling through the pulsation absorbing damper or the like. Since the power transmission device 10 is configured symmetrically relative to the shaft center thereof, the lower side is not depicted in the schematic of FIG. 1. The same applies to the following embodiments.

The differential portion 18 includes a single pinion type planetary gear device 26 having a predetermined gear ratio ρ on the order of “0.418”, for example. This planetary gear device 26 includes a sun gear S, a planetary gear P, a carrier CA that supports the planetary gear P in a rotatable and revolvable manner, and a ring gear R engaging with the sun gear S via the planetary gear P, as rotating elements (elements). When ZS denotes the number of teeth of the sun gear S and ZR denotes the number of teeth of the ring gear R, the gear ratio ρ is ZS/ZR. In this planetary gear device 26, the sun gear S corresponds to a first rotating element. The carrier CA is coupled to the input shaft 16, i.e., the engine 12 and is an input rotating member corresponding to a second rotating element. The ring gear R is coupled to the transmitting member 20 and is an output rotating member corresponding to a third rotating element. Therefore, the planetary gear device 26 corresponds to a differential mechanism that includes the sun gear S as the first rotating element, the carrier CA as the second rotating element that is an input rotating member coupled to the engine 12, and the ring gear R as the third rotating element that is an output rotating member.

The differential portion 18 also includes a first electric motor M1 coupled to the sun gears that is the first rotational element of the planetary gear device 26 and a second electric motor M2 coupled to the transmitting member 20 rotated integrally with the ring gear R that is the third rotating element. Although both the first electric motor M1 and the second electric motor M2 are so-called motor generators that function as motors and generators, the first electric motor M1 at least includes a generator (electric generation) function for generating a reaction force and the second electric motor M2 at least includes a motor function for outputting a drive force as a drive power source for traveling. With this configuration, the differential portion 18 functions as an electric differential portion that controls the differential state of an input rotation speed (rotation speed of the input shaft 16) and an output rotation speed (rotation speed of the transmitting member 20) by controlling the operation state through the first electric motor M1 and the second electric motor M2.

In the differential state of the differential portion 18 configured as described above, a differential action is achieved by enabling the rotation of the three rotating elements, i.e., the sun gear S, the carrier CA, and the ring gear R relative to each other in the planetary gear device 26. Since this configuration distributes the output of the engine 12 to the first electric motor M1 and the transmitting member 20 and realizes operations such as accumulating an electric energy generated by the first electric motor M1 from a portion of the distributed output and rotationally driving the second electric motor M2, the differential portion 18 is allowed to function as an electric differential device and achieve a so-called continuously variable transmission state (electric CVT state), for example, and the rotation of the transmitting member 20 is continuously varied regardless of a predetermined rotation of the engine 12. In other words, the differential portion 18 functions as an electric continuously variable transmission with a transmission gear ratio γ0 (rotation speed N of the input shaft 16/rotation speed N₂₀ of the transmitting member 20) continuously varied from a minimum value γ0ₘᵢₙ to a maximum value γ0ₘₐₓ.

The automatic shifting portion (automatic transmission portion) 22 is a stepped mechanical shifting portion including, for example, a plurality of engaging elements to selectively establish a plurality of shift stages (transmission gear ratios) through the combinations of engagement and release of the engaging elements. The engaging elements are hydraulic friction engagement devices frequently used, for example, in conventional vehicle automatic transmissions, are made up as, for example, a wet multi-plate type with a hydraulic actuator pressing a plurality of friction plates overlapped with each other or as a band brake with a hydraulic actuator fastening one end of one or two bands wrapped around an outer peripheral surface of a rotating drum, and are intended to selectively couple members on the both sides of the engaging elements interposed therebetween. In the automatic shifting portion 22, preferably, the clutch-to-clutch shift is executed by the release of a release-side engaging element and the engagement of an engagement-side engaging element and the gear stages (shift stages) are selectively established to acquire a transmission gear ratio γ (=rotation speed N₂₀ of the transmitting member 20/rotation speed N_{OUT} of the output shaft 24) varying in substantially equal ratio for each gear stage. This automatic shifting portion 22 has an input shaft selectively coupled to the transmitting member 20 via an engaging element not depicted. In other words, the automatic shifting portion 22 is configured to be selectively switchable between the power transmission enabled state that enables the power transmission through the power transmission path from the transmitting member 20 to the automatic shifting portion 22 and the power transmission interrupted state that interrupts the power transmission through the power transmission path.

FIG. 2 is a collinear diagram capable of representing, on straight lines, the relative relationships of the rotation speeds of the three rotating elements included in the planetary gear device 26 with regard to the differential portion 18. In the collinear diagram of FIG. 2, the horizontal axis indicates the relationship of the gear ratio ρ of the planetary gear device 26 and the vertical axes indicate relative rotation speeds. In the relationship among the vertical axes of this collinear diagram, when an interval between a sun gear and a carrier, is defined as an interval corresponding to “1”, an interval between the carrier and a ring gear is defined as an interval corresponding to the gear ratio ρ of a planetary gear device. Therefore, in the case of the planetary gear device 26, the interval between a vertical line Y1 corresponding to the sun gear S and a vertical line Y2 corresponding to the carrier CA is set to an interval corresponding to “1”, and the interval between the vertical line Y2 and a vertical line Y3 corresponding to the ring gear R is set to an interval corresponding to the gear ratio ρ.

When the differential portion 18 is explained by using the collinear diagram of FIG. 2, the sun gear S1 as the first rotating element of the planetary gear device 26 is coupled to the first electric motor M1; the carrier CA as the second rotating element is coupled to the input shaft 16, i.e., the engine 12; the ring gear R as the third rotating element is coupled to the second electric motor M2; and the rotation of the input shaft 16 is configured to be transmitted (input) via the transmitting member 20 to the automatic shifting portion 22. The intersecting points between a diagonal line L and the vertical lines Y1, Y2, and Y3 depicted in FIG. 2 indicate the rotation speeds of the sun gear S (the first electric motor M1), the carrier CA (the engine 12), and the ring gear R (the second electric motor M2).

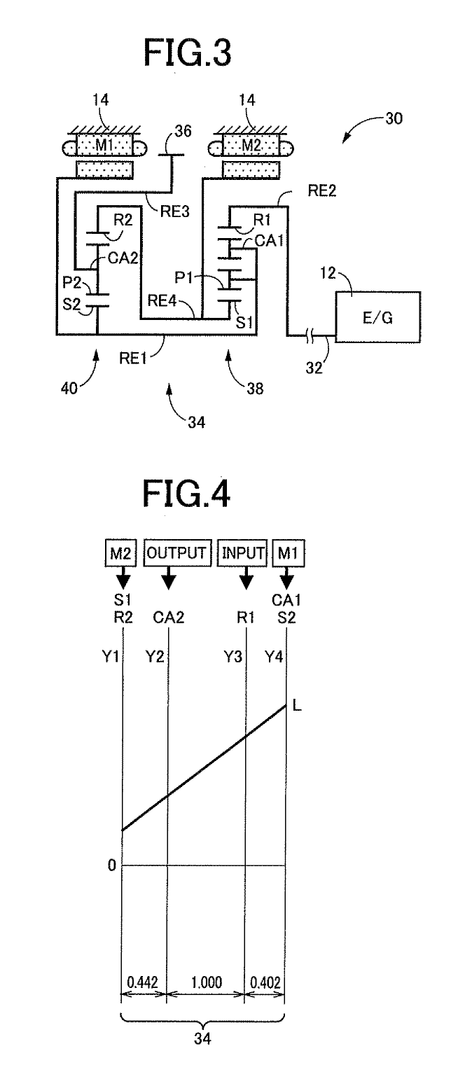

FIG. 3 is a schematic for explaining another example of a configuration of a power transmission device of a hybrid vehicle to which the present invention is preferably applied. In a power transmission device 30 in FIG. 3, the same numerals are given for the common member in the power transmission device 10 in FIG. 1, and the explanations form them are omitted. The power transmission device 30 depicted in FIG. 3 is preferably used as a mechanism for transmitting power output from an engine 12 that is a drive power source to drive wheels (not shown) for, for example, an FF (front-engine front-drive) type vehicle with the power transmission device 10 longitudinally placed in the vehicle. And the power transmission device 10 includes, in series, an input shaft 32 coupled to an output shaft (crankshaft) of the engine 12; a differential portion 34 coupled to the input shaft 32 directly or indirectly via a pulsation absorbing damper (pulsation damping device) not depicted or the like; and an output gear 36 as an output member of the differential portion 34, which are disposed on a common shaft center in the case 14 that is a non-rotating member attached to a vehicle body.

The differential portion 34 includes a double pinion type first planetary gear device 36 having a predetermined gear ratio ρ1 on the order of “0.402”, for example, and a single pinion type second planetary gear device 40 having a predetermined gear ratio p2 on the order of “0.442”, for example. The first planetary gear device 38 includes a sun gear S1, a planetary gear P1, a carrier CA1 that supports the planetary gear P1 in a rotatable and revolvable manner, and a ring gear R1 engaging with the sun gear S1 via the planetary gear P1, as rotating elements (elements). The second planetary gear device 40 includes a sun gear 52, a planetary gear P2, a carrier CA2 that supports the planetary gear P2 in a rotatable and revolvable manner, and a ring gear R2 engaging with the sun gear 52 via the planetary gear P2, as rotating elements (elements).

In the first planetary gear device 38, the ring gear R1 is coupled to the input shaft 32, i.e., the engine 12. The carrier CA1 is coupled to the sun gear S2 of the second planetary gear device 40 and is coupled to the first electric motor M1. The sun gear S1 is coupled to the ring gear R2 of the second planetary gear device 40 and is coupled to the second electric motor M2. In the second planetary gear device 40, the carrier CA2 is coupled to the output gear 36. In the differential portion 34 configured as described above, the carrier CA1 of the first planetary gear device 38 and the sun gear S2 of the second planetary gear device 40 coupled to each other correspond to a first rotating element RE1. The ring gear R1 of the first planetary gear device 38 corresponds to a second rotating element RE2 that is an input rotating member coupled to the engine 12. The carrier CA2 of the second planetary gear device 40 corresponds to a third rotating element RE3 that is an output rotating member. The sun gear S1 of the first planetary gear device 38 and the ring gear R2 of the second planetary gear device 40 coupled to each other correspond to a fourth rotating element RE4. With such a configuration, the second electric motor M2 coupled to the fourth rotating element RE4 is coupled to the third rotating element RE3 in a manner enabling the power transmission. Therefore, the first planetary gear device 38 and the second planetary gear device 40 have the rotating elements coupled to each other as described above and correspond to a differential mechanism.

The differential portion 34 configured as described above functions as an electric differential portion that controls the differential state of an input rotation speed (rotation speed of the input shaft 32) and an output rotation speed (rotation speed of the output gear 36) by controlling the operation state through the first electric motor M1 and the second electric motor M2. In other words, in the differential state, a differential action is achieved by enabling the rotation of the three rotating elements, i.e., the first rotating element RE1, the second rotating element RE2, and the third rotating element RE3 relative to each other in the first planetary gear device 38 and the second planetary gear device 40 having the rotating elements coupled to each other. Since this configuration distributes the output of the engine 12 to the first electric motor M1 and the output gear 36 and realizes operations such as accumulating an electric energy generated by the first electric motor M1 from a portion of the distributed output and rotationally driving the second electric motor M2, the differential portion 34 is allowed to function as an electric differential device and achieve a so-called continuously variable transmission state (electric CVT state), for example, and the rotation of the output gear 36 is continuously varied regardless of a predetermined rotation of the engine 12. In other words, the differential portion 34 functions as an electric continuously variable transmission with a transmission gear ratio γ0 (rotation speed N_{IN} of the input shaft 32/rotation speed N₃₆ of the output gear 36) continuously varied from a minimum value γ0ₘᵢₙ to a maximum value γ0ₘₐₓ.

FIG. 4 is a collinear diagram capable of representing, on straight lines, the relative relationships of the rotation speeds of the four rotating elements in the first planetary gear device 38 and the second planetary gear device 40 having the rotating elements coupled to each other with regard to the differential portion 34. In the collinear diagram of FIG. 4, the horizontal axis indicates the relationship of the gear ratios β1, ρ2 of the first planetary gear device 38 and the second planetary gear device 40 respectively and the vertical axes indicate relative rotation speeds. When the differential portion 34 is represented by using the collinear diagram of FIG. 4, in the differential portion 34 the sun gear S1 of the first planetary gear device 38 and the ring gear R2 of the second planetary gear device 40 coupled to each other are coupled as the fourth rotating element RE4 to the second electric motor M2; the carrier CA2 of the second planetary gear device 40 is coupled as the third rotating element RE3 to the output gear 36; the ring gear R1 of the first planetary gear device 38 is coupled as the second rotating element to the input shaft 32, i.e., the engine 12; the carrier CA1 of the first planetary gear device 38 and the sun gear S2 of the second planetary gear device 40 coupled to each other are coupled as the first rotating element RE1 to the second electric motor M2; and the rotation of the input shaft 32 is configured to be transmitted (input) to the output gear 36. The intersecting points between a diagonal line L and the vertical lines Y1, Y2, Y3, and Y4 depicted in FIG. 4 indicate the rotation speeds of the fourth rotating element RE4 (the second electric motor M2), the third rotating element RE3 (the output gear 36), the second rotating element RE2 (the input shaft 32), and the first rotating element RE1 (the first electric motor M1) respectively.

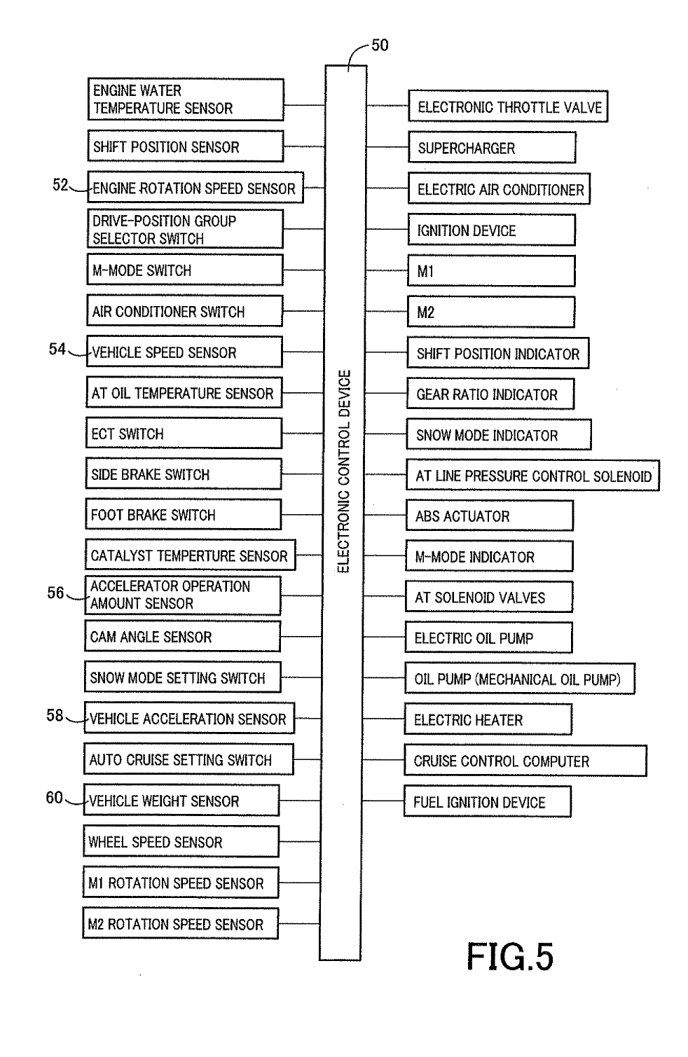

FIG. 5 is a diagram for exemplarily illustrating signals input to an electronic control device 50 for controlling the power transmission devices 10, 30 and signals output from the electronic control device 50. The electronic control device 50 includes a so-called microcomputer made up of CPU, ROM, RAM, I/O interface, etc., and executes signal processes in accordance with programs stored in advance in the ROM, while utilizing a temporary storage function of the RAM, to execute various controls such as the hybrid drive control related to the engine 12, the first electric motor M1, and the second electric motor M2 and the shift control of the automatic shifting portion 22 or the like.

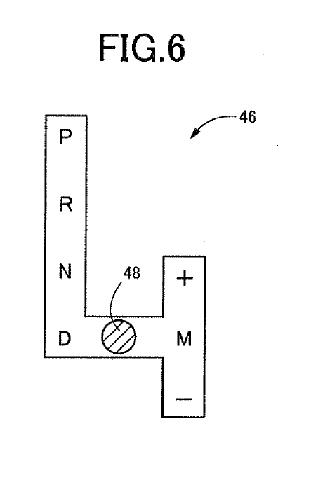

The electronic control device 50 is supplied with various signals from sensors, switches, etc., as depicted in FIG. 5. An engine water temperature sensor supplies a signal indicative of an engine water temperature TEMP_{W}; a shift position sensor supplies signals indicative of a shift position P_{SH} of a shift lever 48 (see FIG. 6) and the number of operations at an “M” position or the like; an engine rotation speed sensor 52 supplies a signal indicative of an engine rotation speed Ne that is the rotation speed of the engine 12; a drive-position group selector switch supplies a signal indicative of a drive-position group selected value; an M-mode switch supplies a signal giving a command for an M-mode (manual shift traveling mode); an air conditioner switch supplies a signal indicative of an operation of an air conditioner; a vehicle speed sensor 54 supplies a signal indicative of a vehicle speed V corresponding to the rotation speed N_{OU} of the output shaft 24 or the output gear 36 (hereinafter, output shaft rotation speed); an AT oil temperature sensor supplies a signal indicative of an operating oil temperature T_{OIL} of the automatic shifting portion 22; a parking brake switch supplies a signal indicative of a parking brake operation; a foot brake switch supplies a signal indicative of a foot brake operation; a catalyst temperature sensor supplies a signal indicative of a catalyst temperature; an accelerator opening degree sensor 56 supplies a signal indicative of an accelerator opening degree Ace that is an amount of an accelerator pedal operation corresponding to an output request amount of a driver; a cam angle sensor supplies a signal indicative of a cam angle; a snow mode setting switch supplies a signal indicative of a snow mode setup; a vehicle acceleration sensor 58 supplies a signal indicative of longitudinal acceleration G of a vehicle; an auto-cruise setting switch supplies a signal indicative of auto-cruise travelling; a vehicle weight sensor 60 supplies a signal indicative of a vehicle's mass (vehicle weight) W; a wheel speed sensor supplies a signal indicative of a wheel speed for each of wheels (left and right pairs of front and rear wheels); an M1-rotation speed sensor supplies a signal indicative of a rotation speed Nm1 of the first electric motor M1; an M2-rotation speed sensor supplies a signal indicative of a rotation speed Nm2 of the second electric motor M2; and a battery sensor supplies a signal indicative of a charging capacity (state of charge) SOC of an electric storage device 66 (see FIG. 7).

The electronic control device 50 outputs control signals to an engine output control device 62 (see FIG. 7) that controls engine output, for example, a drive signal to a throttle actuator that operates a throttle valve opening degree θ_{TH} of an electronic throttle valve disposed in an induction pipe of the engine 12, a fuel supply amount signal that controls a fuel supply amount into the induction pipe or cylinders of the engine 12 from a fuel injection device, or an ignition signal that gives a command for timing of the ignition of the engine 12 by an ignition device or the like. The electronic control device 50 also outputs a charging pressure adjusting signal for adjusting a charging pressure; an electric air conditioner drive signal for activating an electric air conditioner; command signals that gives commands for the operation of the electric motors M1 and M2; a shift position (operational position) display signal for activating a shift indictor; a gear ratio display signal for displaying a gear ratio; a snow mode display signal for displaying that the snow mode is in operation; an ABS activation signal for activating an ABS actuator that prevents wheels from slipping at the time of braking; an M-mode display signal for displaying that the M-mode is selected; a valve command signal for activating an electromagnetic valve (linear solenoid valve) included in a hydraulic control circuit not depicted so as to control the hydraulic actuator of the hydraulic friction engagement devices included in the automatic shifting portion 22, etc.; a signal for regulating a line oil pressure P_{L} with a regulator valve (pressure regulating valve) disposed in the hydraulic control circuit; a drive command signal for activating an electric hydraulic pump that is an oil pressure source of an original pressure for regulating the line oil pressure P_{L}; a signal for driving an electric heater; and a signal to a computer for controlling the cruise control or the like.

FIG. 6 is a diagram of an example of a shift operation device 46 as a switching device that switches a plurality of types of shift positions P_{SH} through artificial operation. The shift operation device 46 is disposed next to a driver's seat, for example, and includes a shift lever 48 operated so as to select the plurality of types of shift positions P_{SH}. The shift lever 48 is arranged to be manually operated to a parking position “P (parking)” for being in a neutral state with the power transmission path interrupted in the power transmission devices 10, 30 and for locking the output shaft of the power transmission devices 10, 30; a backward traveling position “R (reverse)” for backward traveling; a neutral position “N (neutral)” for being in the neutral state with the power transmission path interrupted in the power transmission devices 10, 30; a forward traveling and automatic shifting position “D (drive)” for achieving an automatic transmission mode to execute the automatic transmission control within an available variation range of a total transmission gear ratio γT of the power transmission devices 10, 30 acquired from a continuous transmission gear ratio width of the differential portions 18, 34 and, in the case of the power transmission device 10, additionally from the gear stages achieved in the automatic shifting portion 22; or a forward traveling and manual shifting position “M (manual)” for achieving a manual transmission traveling mode (manual mode) to realize the stepped transmission with a plurality of shift stages in the power transmission devices 10, 30.

FIG. 7 is a functional block diagram for explaining a main portion of the control function equipped in the electronic control device 50. FIG. 7 explains the control function corresponding to the power transmission devices 10, 30 and schematically depicts the engine output control device 62, an inverter 64, the electric storage device 66, etc., as constituent elements common to the power transmission devices 10, 30 while exemplarily illustrating the configurations of the output shaft 24, the differential gear device 42, and the drive wheels 44 as those related to the power transmission device 10.

A hybrid control portion 70 depicted in FIG. 7 implements the hybrid drive control in the power transmission devices 10, 30 by controlling the drive of the engine 12, the first electric motor M1, and the second electric motor M2 through the engine output control device 62. For example, while the engine 12 is operated in an efficient operation range, the allotment of the drive force between the engine 12 and the second electric motor M2 and the reaction force due to the electric generation by the first electric motor M1 are changed to the optimum state to control the transmission gear ratio γ0 of the differential portions 16, 32 as the electric continuously variable transmission. Preferably, for a traveling vehicle speed V at a time point, a target (request) output of a vehicle is calculated from the accelerator opening degree Ace that is an output request amount of a driver and the vehicle speed V, and a necessary total target output is calculated from the target output and a charge request value of the vehicle to calculate a target engine output such that the total target output is acquired in consideration of a transmission loss, loads of accessories, an assist torque of the second electric motor M2, etc. The engine 12 is controlled while an amount of the electric generation of the first electric motor M1 is controlled so as to achieve the engine rotation speed Ne or the engine torque T_{E} capable of acquiring the target engine output.

With regard to the control related to the power transmission device 10, the hybrid control portion 70 executes the control in consideration of the shift stages of the automatic shifting portion 22 to improve power performance, fuel consumption, etc. In such hybrid control, the differential portion 18 is driven to function as an electric continuously variable transmission to match the engine rotation speed Ne and determined for operating the engine 12 in an efficient operation range with the rotation speed of the transmitting member 20 determined from the vehicle speed V and the shift stages of the automatic shifting portion 22. Therefore, the hybrid control portion 70 determines a target value of the total transmission gear ratio γT of the power transmission device 10, controls the transmission gear ratio γ0 of the differential portion 18 in consideration of the shift stages of the automatic shifting portion 22 to acquire the target value, and controls the total transmission gear ratio γT within the available variation range such that the engine 12 is operated along the optimal fuel consumption curve (fuel consumption map, relationship) of the engine 12 defined in the two-dimensional coordinates made up of the engine rotation speed Ne and the output torque (engine torque) T_{E} of the engine 12 which is empirically obtained and stored in advance so as to satisfy both the drivability and the fuel consumption property at the time of travelling with continuously variable transmission, for example, such that the engine torque T_{E} and the engine rotation speed Ne are achieved for generating the engine output necessary for satisfying the target output (the total target output, the request drive force).

For the control as described above, the hybrid control portion 70 supplies the electric energy generated by the first electric motor M1 to the electric storage device 66 and the second electric motor M2 via the inverter 64. As a result, a main portion of the power of the engine 12 is mechanically transmitted to the transmitting member 20 or the output gear 36 while a portion of the power is consumed for the electric generation of the first electric motor M1 and converted into an electric energy, and the electric energy is supplied through the inverter 64 to the second electric motor M2. The second electric motor M2 is driven and the power is transmitted from the second electric motor M2 to the transmitting member 20 or the output gear 36. The equipments related to the electric energy from the generation to the consumption by the second electric motor M2 make up an electric path from the conversion of a portion of the power of the engine 12 into an electric energy to the conversion of the electric energy into a mechanical energy.

The hybrid control portion 70 controls the engine rotation speed Ne by controlling the rotation speed Nm1 of the first electric motor M1 and/or the rotation speed Nm2 of the second electric motor M2 with using the electric CVT function of the differential portions 18, 34 such that the engine rotation speed Ne is maintained substantially constant or controlled at an arbitrary rotation speed regardless of whether a vehicle is stopped or traveling. In other words, while the engine rotation speed Ne is maintained substantially constant or controlled at an arbitrary rotation speed, the rotation speed Nm1 of the first electric motor M1 and/or the rotation speed Nm2 of the second electric motor M2 are controlled to be an arbitrary rotation speed.

For example, as can be seen from the collinear diagram of FIG. 2, if the engine rotation speed Ne is increased in the power transmission devices 10 while a vehicle is traveling, the hybrid control portion 70 increases the rotation speed Nm1 of the first electric motor M1 while maintaining the substantially constant rotation speed Nm2 of the second electric motor M2, which is bound by the vehicle speed V. If the engine rotation speed Ne is maintained substantially constant during the shift of the automatic shifting portion 22, the rotation speed Nm1 of the first electric motor M1 is changed in the opposite direction from the change in the rotation speed Nm2 of the second electric motor M2 associated with the shift of the automatic shifting portion 22 while maintaining the engine rotation speed Ne substantially constant.

The hybrid control portion 70 controls the output of the engine 12 through the engine output control device 62. For example, a target rotation speed N_{ELINE} of the engine 12 is calculated from a relationship (not depicted) stored in advance, based on the accelerator opening degree Acc, the vehicle speed V, etc., and the rotation speed (drive) of the engine 12 is controlled such that the actual rotation speed Ne of the engine 12 is to be the target rotation speed N_{ELINE}. Based on the target rotation speed N_{ELINE} calculated in such a way (i.e., in accordance with a command corresponding to the target rotation speed N_{ELINE}), the engine output control device 62 executes the engine rotation speed control (engine output control) by controlling opening/closing of the electronic throttle valve with the throttle actuator as well as controlling the fuel injection of the fuel injection device for the fuel injection control, controlling the timing of the ignition by the ignition device such as an igniter for the ignition timing control, etc.

The hybrid control portion 70 can achieve the motor traveling with the electric CVT function (differential action) of the differential portions 18, 34 regardless of whether the engine 12 is stopped or in the idle state. For example, this motor traveling is performed in a relatively lower output torque T_{OUT} zone, i.e., a lower engine torque T_{E} zone generally considered as having poor engine efficiency as compared to a higher torque zone, or a relatively lower vehicle speed zone of the vehicle speed V, i.e., a lower load zone. During the motor traveling, to suppress the drag of the stopped engine 12 and improve the fuel consumption, the rotation speed Nm1 of the first electric motor M1 is controlled at a negative rotation speed to allow freely rotating by, for example, achieving a no-load state, and the engine rotation speed Ne is maintained at zero or substantially zero as needed with the electric CVT function (differential action) of the differential portions 18, 34.

The hybrid control portion 70 can perform so-called torque assist for complementing the power of the engine 12 even in the engine traveling range by supplying the electric energy from the first electric motor M1 and/or the electric energy from the electric storage device 66 through the electric path described above to the second electric motor M2 and by driving the second electric motor M2 to apply a torque to the drive wheels 44.

The hybrid control portion 70 has a function as a regenerative control portion that rotationally drives the second electric motor M2 to operate as an electric generator by a kinetic energy of a vehicle, i.e., a reverse drive force transmitted from the drive wheels 44 toward the engine 12 and that charges the electric storage device 66 through the inverter 64 with the electric energy, i.e., a electric current generated by the second electric motor M2 to improve the fuel consumption during the inertia traveling (during coasting) when the acceleration is turned off and at the time of braking by the foot brake, or the like. This regenerative control is controlled to achieve a regenerative amount determined based on a charging capacity SOC of the electric storage device 66 and the braking force distribution of a braking force from a hydraulics brake for acquiring a braking force corresponding to a brake pedal operation amount, or the like.

The hybrid control portion 70 includes an inertia torque compensation control portion 72 for executing the inertia torque compensation control of the first electric motor M1 at the time of acceleration of a vehicle. The electronic control device 50 includes an engine rotation speed determining portion 74 that determines whether the actual rotation speed Ne of the engine 12 at a time point detected by the engine rotation speed sensor 52 is equal to or greater than a predetermined threshold value for the control by the inertia torque compensation control portion 82. Preferably, the engine rotation speed determining portion 74 determines whether the actual rotation speed Ne of the engine 12 at a time point detected by the engine rotation speed sensor 52 is equal to or greater than a first threshold value N_{TS1} with regard to the first threshold value N_{TS1} related to the execution condition of the inertia torque compensation control by the inertia torque compensation control portion 82 and also determines whether the actual rotation speed Ne of the engine 12 at a time point detected by the engine rotation speed sensor 52 is equal to or greater than a second threshold value N_{TS2} with regard to the second threshold value N_{TS2} related to the limitation control of a compensation torque in the inertia torque compensation control by the inertia torque compensation control portion 82.

As depicted in FIG. 7, the electronic control device 50 includes control functions for determining fulfillment of various conditions in relation to the control by the inertia torque compensation control portion 82, i.e., a road surface slope determining portion 76 that determines whether a slope angle θ of a road surface on which a vehicle travels calculated based on the longitudinal acceleration G of a vehicle detected by the vehicle acceleration sensor 58 in accordance with a predetermined relationship is equal to or greater than a predetermined angle θ_{TS} defined in advance, a vehicle mass determining portion 78 that determines whether the actual vehicle mass W at a time point detected by the vehicle weight sensor 60 is equal to or greater than a predetermined value W_{TS} defined in advance, an accelerator opening degree determining portion 80 that determines whether the actual accelerator opening degree Ace at a time point detected by the accelerator opening degree sensor 56 is equal to or greater than a predetermined value A_{TS} defined in advance, and a vehicle start determining portion 82 that determines whether a vehicle is in a case of starting based on the actual vehicle speed V at a time point detected by the vehicle speed sensor 54.

The inertia torque compensation control portion 82 executes the inertia torque compensation control that drives the first electric motor M1 to generate a compensation torque ΔTm1 for reducing an inertia torque Tit generated in the first electric motor M1 in association with a change in rotation speed of the second electric motor M2 at the time of acceleration of a vehicle. In other words, if a rotation speed changes in the second electric motor M2, the compensation torque ΔTm1 is generated in the first electric motor M1 so as not to transmit a torque caused by a rotation speed change and inertia moment of the first electric motor M1 to the shaft of the second electric motor M2. Preferably, the compensation torque ΔTm1 is determined by preliminarily empirically obtaining a value corresponding to the inertia torque Tit generated in the first electric motor M1 in association with a change in rotation speed of the second electric motor M2 at the time of acceleration of a vehicle and may be a value determined as a variable based on acceleration or may be a predetermined value regardless of acceleration. The compensation torque ΔTm1 is basically calculated as a product of the inertia moment and target angular acceleration of the first electric motor M1. For reference, the inertia moment in the first electric motor M1 may reach 6% of a vehicle weight when converted on a tire axis and, for example, in the case of a vehicle weight of 3500 kg, the axle-reduced value of the inertia moment reaches about 200 kg.

Preferably, the inertia torque compensation control portion 82 executes the inertia torque compensation control only if the determination of the engine rotation speed determining portion 74 is positive for the first threshold value N_{TS1}, i.e., if the actual rotation speed Ne of the engine 12 at a time point of the determining is equal to or greater than the first threshold value N_{TS1}. In other words, the inertia torque compensation control is not executed if the actual rotation speed Ne of the engine 12 at a time point of the determining is less than the first threshold value N_{TS1}.

Preferably, the inertia torque compensation control portion 82 executes the inertia torque compensation control if the determination of the road surface slope determining portion 76 is positive, i.e., if or greater the slope angle θ of a road surface on which a vehicle travels is equal to or greater than the predetermined angle θ_{TS} defined in advance. Preferably, the inertia torque compensation control is executed if the determination of the vehicle mass determining portion 78 is positive, i.e., if the vehicle's mass W is equal to or greater than the predetermined value W_{TS} defined in advance. Preferably, the inertia torque compensation control is executed if the determination of the accelerator opening degree determining portion 80 is positive, i.e., if the accelerator opening degree Acc is equal to or greater than the predetermined value A_{TS} defined in advance. In other words, preferably, the inertia torque compensation control portion 82 executes the inertia torque compensation control if positive determination is made by at least one of the road surface slope determining portion 76, the vehicle mass determining portion 78, and the accelerator opening degree determining portion 80.

Preferably, the inertia torque compensation control portion 82 temporarily executes the inertia torque compensation control if the determination of the vehicle start determining portion 82 is positive, i.e., at the start of a vehicle. For example, the inertia torque compensation control is executed at the start of a vehicle while the engine 12 is stopped, i.e., at the start of a vehicle in the EV start mode in which the second electric motor M2 is used as a power source.

Preferably, the inertia torque compensation control portion 82 executes the inertia torque compensation control for the power transmission device 10 including the automatic shifting portion 22 in accordance with a change in rotation speed of the second electric motor M2 associated with the shift of the automatic shifting portion 22. For example, the control is executed in accordance with a change in rotation speed of the second electric motor M2 at the time of acceleration control associated with the downward shift (down shifting) of the automatic shifting portion 22.

Preferably, if the determination of the engine rotation speed determining portion 74 is positive for the second threshold value N_{TS2}, i.e., if the actual rotation speed Ne of the engine 12 at a time point of the determining is equal to or greater than the second threshold value N_{TS2}, the inertia torque compensation control portion 82 limits the compensation torque ΔTm1 generated in the inertia torque compensation control as compared to the case of less than the second threshold value N_{TS2}. Specifically, an absolute value of the compensation torque ΔTm1 generated in the inertia torque compensation control is reduced as compared to the case that the rotation speed Ne of the engine 12 is less than the second threshold value N_{TS2}. Preferably, the inertia torque compensation control portion 82 puts a limit on the compensation torque ΔTm1 depending on the output limitation of the first electric motor M1 such that the upper limit of the absolute value becomes equal to or less than a predetermined value.

Preferably, the control of limiting the compensation torque ΔTm1 is executed to prevent the negative rotation of the engine 12. If the inertia torque compensation control may swing the rotation speed Ne of the engine 12 toward the negative side and cause the negative rotation, the compensation torque ΔTm1 is limited to prevent the negative rotation of the engine 12. Therefore, preferably, if the absolute value of the actual rotation speed Ne of the engine 12 at a time point of the determining is equal to or greater than the threshold value N_{TS} defined in advance, the inertia torque compensation control portion 82 limits the compensation torque ΔTm1 generated in the inertia torque compensation control as compared to the case of less than the threshold value N_{TS}.

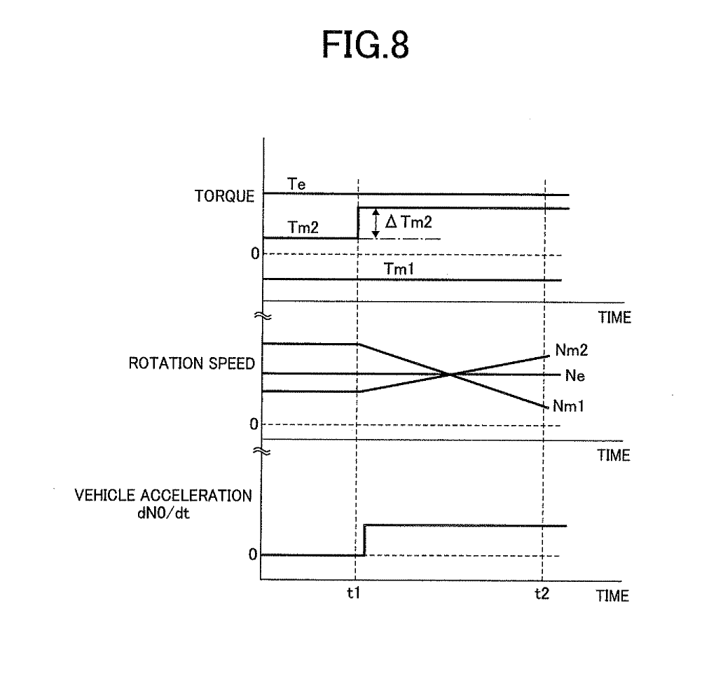

FIG. 8 is a time chart of an example of changes with time in torque and rotation speed of each of the engine 12, the first electric motor M1, and the second electric motor M2 of the power transmission device 10 depicted in FIG. 1 at the time of acceleration of a vehicle, corresponding to the control in a conventional technique. In the example depicted in FIG. 8, first, at time point t1, an acceleration command is output due to the execution of a pressing operation of an accelerator pedal not depicted or the execution of the shift of the automatic shifting portion 22, or the like, and a torque Tm2 of the second electric motor M2 is increased by a predetermined value ΔTm2 corresponding to the acceleration. In the control depicted in FIG. 8, a torque Te of the engine 12 and a torque Tm1 of the first electric motor M1 are not changed in accordance with the acceleration command at the time point t1. A vehicle acceleration dNo/dt is increased in accordance with the output torque change in the torque Tm2 of the second electric motor M2 and the rotation speed Nm2 of the second electric motor M2 is gradually increased until time point t2. The rotation speed Nm1 of the first electric motor M1 is accordingly gradually increased and the rotation speed Ne of the engine 12 is maintained.

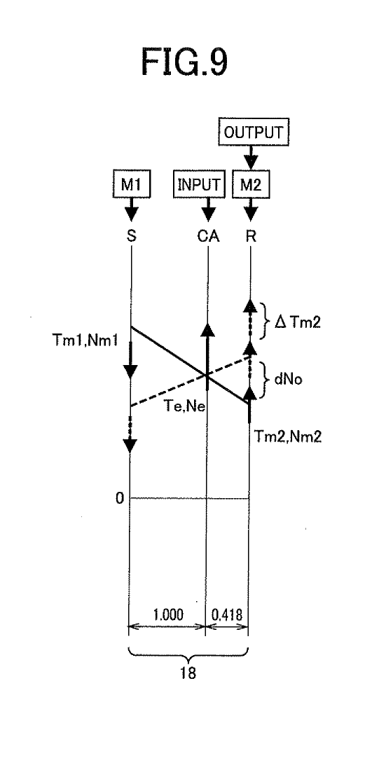

FIG. 9 is a collinear diagram for explaining changes in rotation speeds of the rotating elements in the differential portion 18, corresponding to the time chart depicted in FIG. 8; solid line indicate the rotation speeds of the rotating elements at time point t1; solid arrows indicate the torque directions of the rotating elements at the time point t1; dashed line indicate the rotation speeds at time point t2; and dashed arrows indicate the torque directions of the rotating elements at the time point t2. As depicted in FIG. 9, the second electric motor M2 is driven to generate a torque in the direction increasing the rotation speed, i.e., a positive torque by taking out energy from the electric storage device 66 from the time point 11 until the time point t2. The first electric motor M1 is driven to generate a torque in the direction reducing the rotation speed, i.e., a negative torque (reactive torque). The rotation speed of the engine 12 is maintained constant by the power running control of the second electric motor M2 and a reaction force control of the first electric motor M1. In the control of the conventional technique as depicted in the time chart of FIG. 8, since the rotary inertia of the first electric motor M1 is accelerated in accordance with a change in rotation speed (increase in rotation speed) of the second electric motor M2, a portion of the power output from the second electric motor M2 is used as an inertia torque (inertia moment) generated in the first electric motor M1. Therefore, the power output from the second electric motor M2 cannot entirely be used for the vehicle acceleration and, as a result, the vehicle acceleration decreases and is insufficient and the acceleration intended by a driver cannot sufficiently be acquired.

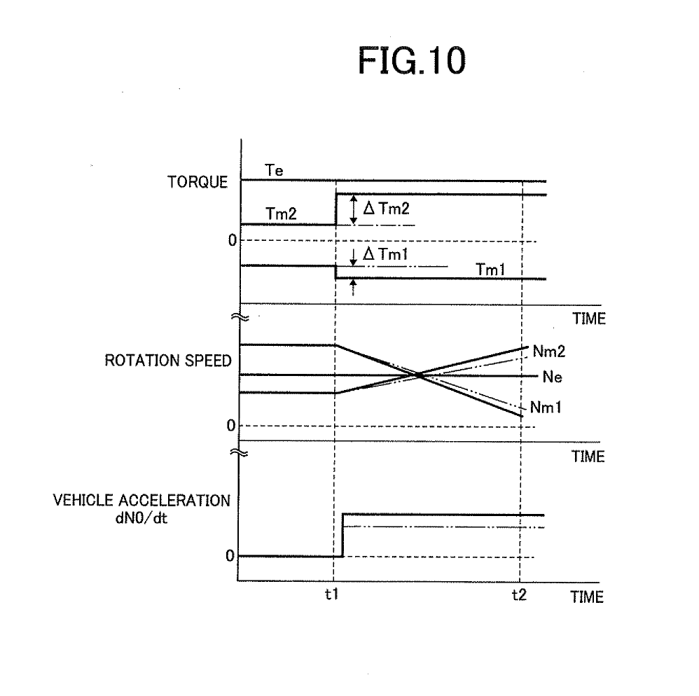

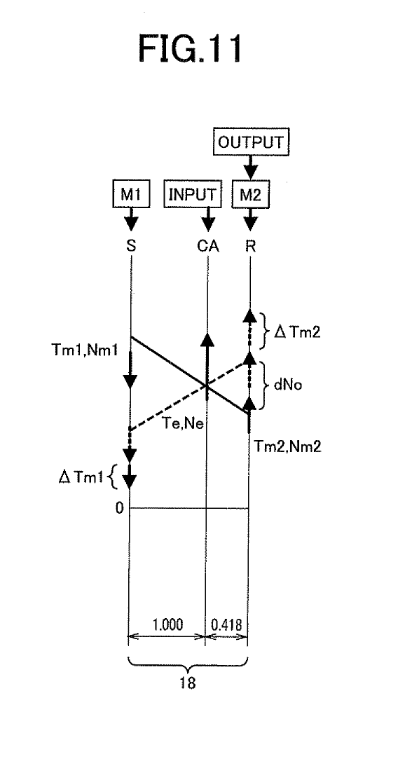

FIG. 10 is a time chart of an example of changes with time in torque and rotation speed of each of the engine 12, the first electric motor M1, and the second electric motor M2 of the power transmission device 10 depicted in FIG. 1 at the time of acceleration of a vehicle, corresponding to the control of this embodiment. FIG. 10 is for the purpose of explaining the control of this embodiment by comparison with the control of FIG. 8 and the values related to the control of the conventional technique depicted in FIG. 8 are indicated by dashed-two dotted lines. In the example depicted in FIG. 10, first, at time point t1, an acceleration command is output due to the execution of a pressing operation of an accelerator pedal not depicted or the execution of the shift of the automatic shifting portion 22 or the like, and a torque Tm2 of the second electric motor M2 is increased by a predetermined value ΔTm2 corresponding to the acceleration. At about the same time as the increase in torque of the second electric motor M2, the compensation torque ΔTm1 is generated in the first electric motor M1 for reducing the inertia torque generated in the first electric motor M1 in association with the increase of the torque ΔTm2 of the second electric motor M2. FIG. 11 is a collinear diagram of a direction of the compensation torque ΔTm1 generated in the first electric motor M1 as described above and, at time point t1, the first electric motor M1 is driven to generate a torque in the direction reducing the rotation speed of the first electric motor M1 (the direction canceling the inertia torque generated due to a change in rotation speed of the second electric motor M2), i.e., a negative torque. This control preferably restrains the torque generated by the second electric motor M2 from being used for the inertia torque in the first electric motor M1 and the rotation speed of the second electric motor M2 is more swiftly increased than the conventional control depicted in FIG. 8. As a result, the vehicle acceleration dNo/dt is increased as compared to the conventional control depicted in FIG. 8. Therefore, in the collinear diagram of FIG. 11, a speed increase dNo between time points t1 and t2 is greater than that depicted in the collinear diagram of FIG. 9, thereby realizing the sufficient acceleration intended by a driver.

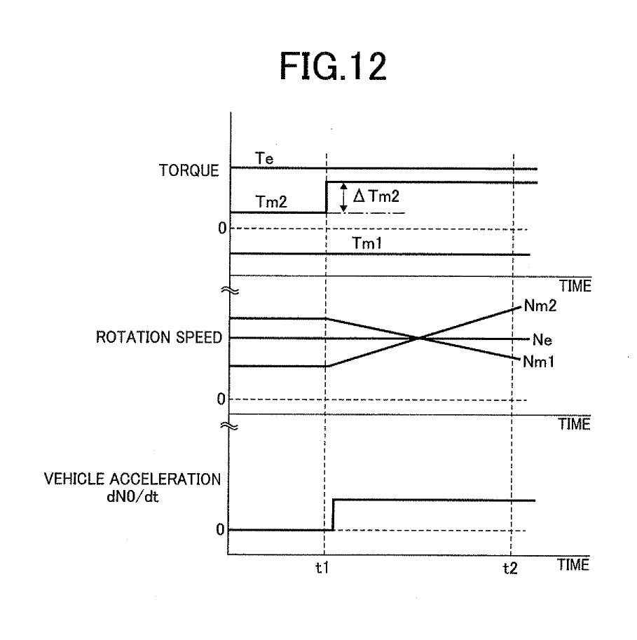

FIG. 12 is a time chart of an example of changes with time in torque and rotation speed of each of the engine 12, the first electric motor M1, and the second electric motor M2 of the power transmission device 30 depicted in FIG. 3 at the time of acceleration of a vehicle, corresponding to the control in a conventional technique. In the example depicted in FIG. 12, first, at time point tit, an acceleration command is output due to the execution of a pressing operation of an accelerator pedal not depicted, or the like, and a torque Tm2 of the second electric motor M2 is increased by a predetermined value ΔTm2 corresponding to the acceleration. In the control depicted in FIG. 12, a torque Te of the engine 12 and a torque Tm1 of the first electric motor M1 are not changed in accordance with the acceleration command at the time point t1. A vehicle acceleration dNo/dt is increased in accordance with the output torque change in the torque Tm2 of the second electric motor M2 and the rotation speed Nm2 of the second electric motor M2 is gradually increased until time point t2. The rotation speed Nm1 of the first electric motor M1 is accordingly gradually increased and the rotation speed Ne of the engine 12 is maintained.

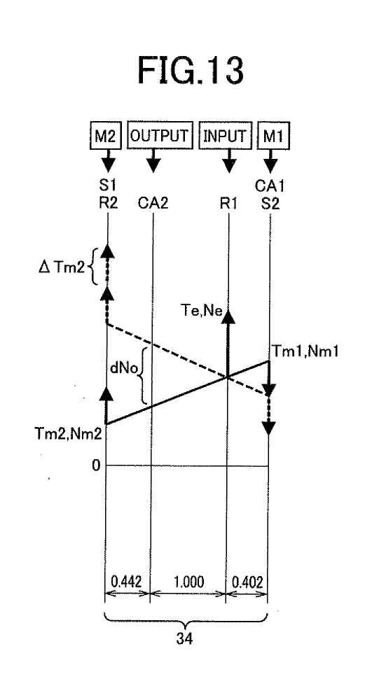

FIG. 13 is a collinear diagram for explaining changes in rotation speeds of the rotating elements in the differential portion 34, corresponding to the time chart depicted in FIG. 12; solid line indicate the rotation speeds of the rotating elements at time point t1; solid arrows indicate the torque directions of the rotating elements at the time point t1; dashed line indicate the rotation speeds at time point t2; and dashed arrows indicate the torque directions of the rotating elements at the time point t2. As depicted in FIG. 13, the second electric motor M2 is driven to generate a torque in the direction increasing the rotation speed, i.e., a positive torque by taking out energy from the electric storage device 66 from the time point t1 until the time point t2. The first electric motor M1 is driven to generate a torque in the direction reducing the rotation speed, i.e., a negative torque. The rotation speed of the engine 12 is maintained constant by the power running control of the second electric motor M2 and a reaction force control of the first electric motor M1. In the control of the conventional technique as depicted in the time chart of FIG. 12, since the rotary inertia of the first electric motor M1 is accelerated in accordance with a change in rotation speed (increase in rotation speed) of the second electric motor M2, a portion of the power output from the second electric motor M2 is used as an inertia torque (inertia moment) generated in the first electric motor M1. Therefore, the power output from the second electric motor M2 cannot entirely be used for the vehicle acceleration and, as a result, the vehicle acceleration decreases and is insufficient and the acceleration intended by a driver cannot sufficiently be acquired.

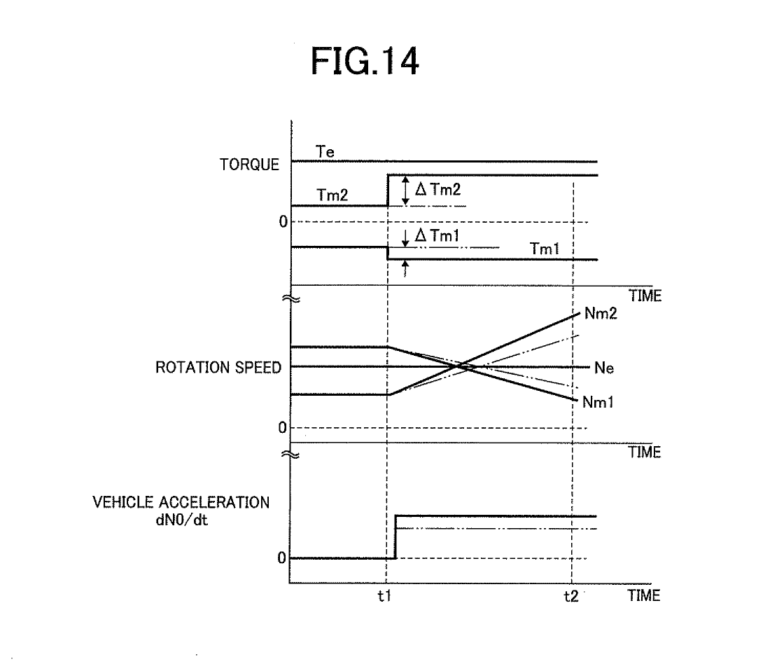

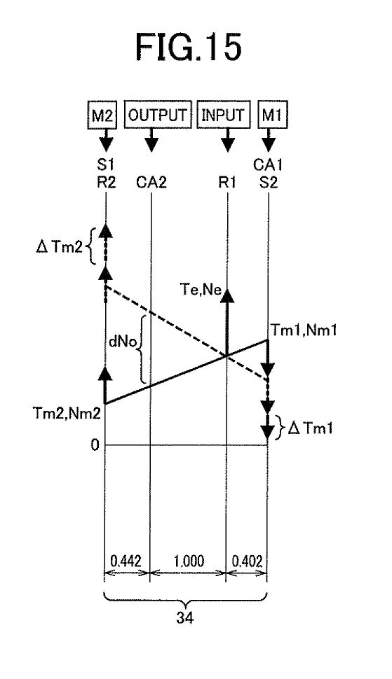

FIG. 14 is a time chart of an example of changes with time in torque and rotation speed of each of the engine 12, the first electric motor M1, and the second electric motor M2 of the power transmission device 10 depicted in FIG. 3 at the time of acceleration of a vehicle, corresponding to the control of this embodiment. FIG. 14 is for the purpose of explaining the control of this embodiment by comparison with the control of FIG. 12 and the values related to the control of the conventional technique depicted in FIG. 12 are indicated by dashed-two dotted lines. In the example depicted in FIG. 14, first, at time point t1, an acceleration command is output due to the execution of a pressing operation of an accelerator pedal not depicted or the like, and a torque Tm2 of the second electric motor M2 is increased by a predetermined value ΔTm2 corresponding to the acceleration. At about the same time as the increase in torque of the second electric motor M2, the compensation torque ΔTm1 is generated in the first electric motor M1 for reducing the inertia torque generated in the first electric motor M1 in association with the increase of the torque ΔTm2 of the second electric motor M2. FIG. 15 is a collinear diagram of a direction of the compensation torque ΔTm1 generated in the first electric motor M1 as described above and, at time point t1, the first electric motor M1 is driven to generate a torque in the direction reducing the rotation speed of the first electric motor M1, i.e., a negative torque. This control preferably restrains the torque generated by the second electric motor M2 from being used for the inertia torque in the first electric motor M1 and the rotation speed of the second electric motor M2 is more swiftly increased than the conventional control depicted in FIG. 12. As a result, the vehicle acceleration dNo/dt is increased as compared to the conventional control depicted in FIG. 12. Therefore, in the collinear diagram of FIG. 15, a speed increase dNo between time points t1 and t2 is greater than that depicted in the collinear diagram of FIG. 13, thereby realizing the sufficient acceleration intended by a driver.

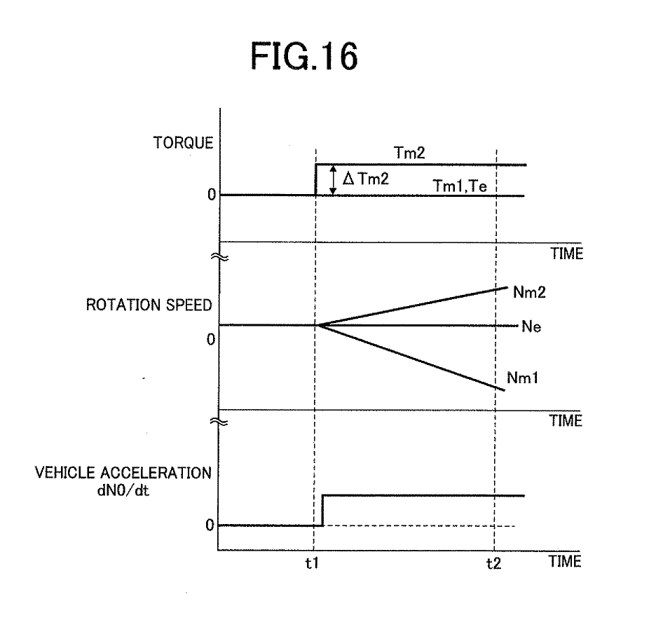

FIG. 16 is a time chart, on starting of the vehicle in EV traveling mode, of an example of changes with time in torque and rotation speed of each of the engine 12, the first electric motor M1, and the second electric motor M2 of the power transmission device 10 depicted in FIG. 1 at the time of acceleration of a vehicle, corresponding to the control in a conventional technique. In the example depicted in FIG. 16, first, at time point t1, an operation for starting of the traveling of the vehicle is performed, and a torque Tm2 of the second electric motor M2 is increased by a predetermined value ΔTm2 corresponding to the acceleration for starting of the vehicle. In the control depicted in FIG. 16, a torque Te of the engine 12 and a torque Tm1 of the first electric motor M1 are not changed and maintained to be zero in accordance with the acceleration command at the time point t1. A vehicle acceleration dNo/dt is increased in accordance with the output torque change in the torque Tm2 of the second electric motor M2 and the rotation speed Nm2 of the second electric motor M2 is gradually increased until time point t2. The rotation speed Nm1 of the first electric motor M1 and the rotation speed Ne of the engine 12 is maintained.

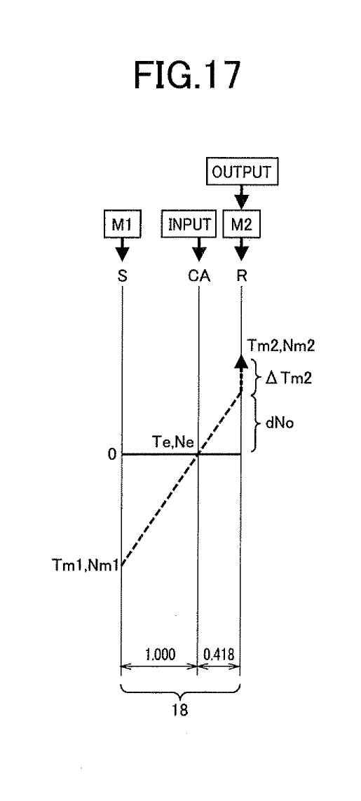

FIG. 17 is a collinear diagram for explaining changes in rotation speeds of the rotating elements in the differential portion 18, corresponding to the time chart depicted in FIG. 16; solid line indicate the rotation speeds of the rotating elements at time point t1; dashed line indicate the rotation speeds at time point t2; and dashed arrows indicate the torque directions of the rotating elements at the time point t2. As depicted in FIG. 17, the second electric motor M2 is driven to generate a torque in the direction increasing the rotation speed, i.e., a positive torque by taking out energy from the electric storage device 66 from the time point t1 until the time point t2. The rotation speed of the engine 12 is maintained constant and the rotation speed of the first electric motor M1 is reduced in accordance with a increase of the rotation speed of the second electric motor M2. In the control of the conventional technique as depicted in the time chart of FIG. 16, since the rotary inertia of the first electric motor M1 is accelerated in accordance with a change in rotation speed (increase in rotation speed) of the second electric motor M2, a portion of the power output from the second electric motor M2 is used as an inertia torque (inertia moment) generated in the first electric motor M1. Therefore, the power output from the second electric motor M2 cannot entirely be used for the vehicle acceleration and, as a result, the vehicle acceleration decreases and is insufficient and the acceleration intended by a driver cannot sufficiently be acquired.

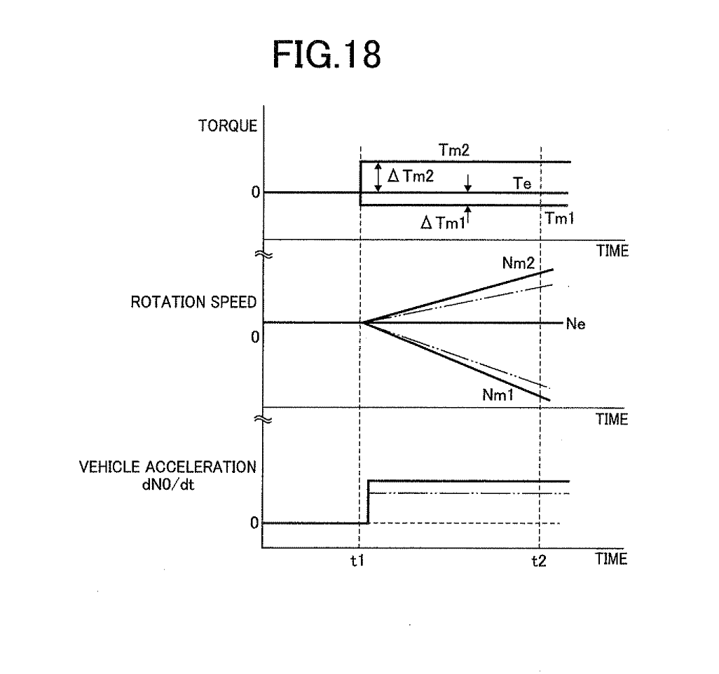

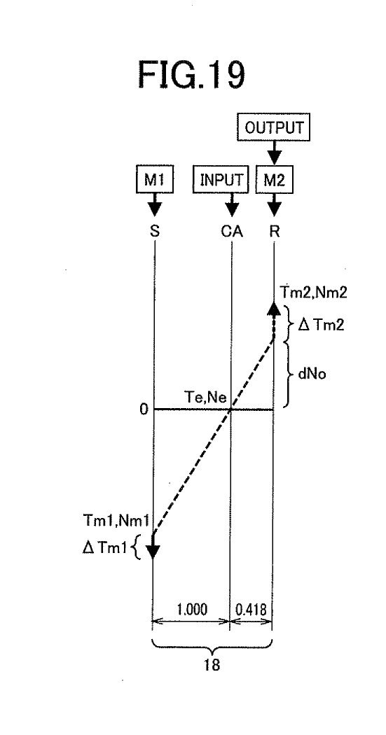

FIG. 18 is a time chart, on starting of the vehicle in EV traveling mode, of an example of changes with time in torque and rotation speed of each of the engine 12, the first electric motor M1, and the second electric motor M2 of the power transmission device 10 depicted in FIG. 1 at the time of acceleration of a vehicle, corresponding to the control of this embodiment. FIG. 18 is for the purpose of explaining the control of this embodiment by comparison with the control of FIG. 16 and the values related to the control of the conventional technique depicted in FIG. 16 are indicated by dashed-two dotted lines. In the example depicted in FIG. 18, first, at time point t1, an operation for starting of the traveling of the vehicle is performed, and a torque Tm2 of the second electric motor M2 is increased by a predetermined value ΔTm2 corresponding to the acceleration for starting of the vehicle. At about the same time as the increase in torque of the second electric motor M2, the compensation torque ΔTm1 is generated in the first electric motor M1 for reducing the inertia torque generated in the first electric motor M1 in association with the increase of the torque ΔTm2 of the second electric motor M2. FIG. 19 is a collinear diagram of a direction of the compensation torque ΔTm1 generated in the first electric motor M1 as described above and, at time point t1, the first electric motor M1 is driven to generate a torque in the direction reducing the rotation speed of the first electric motor M1, i.e., a negative torque. This control preferably restrains the torque generated by the second electric motor M2 from being used for the inertia torque in the first electric motor M1 and the rotation speed of the second electric motor M2 is more swiftly increased than the conventional control depicted in FIG. 16. As a result, the vehicle acceleration dNo/dt is increased as compared to the conventional control depicted in FIG. 16. Therefore, in the collinear diagram of FIG. 19, a speed increase dNo between time points t1 and t2 is greater than that depicted in the collinear diagram of FIG. 17, thereby realizing the sufficient acceleration intended by a driver.

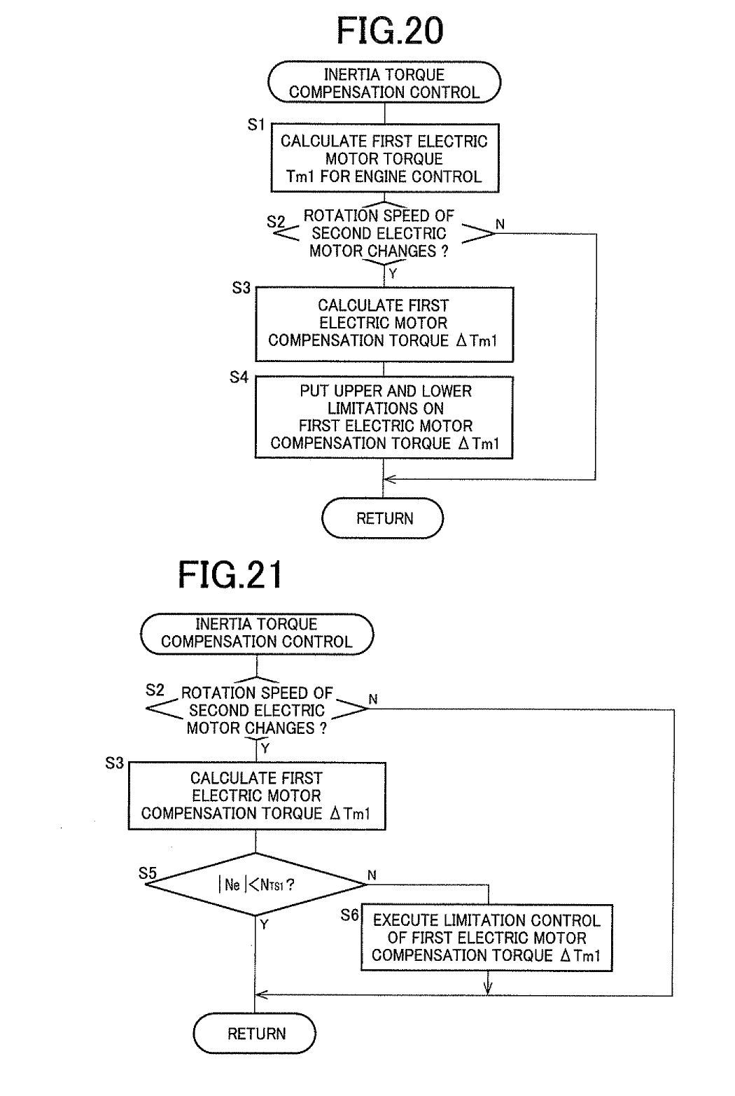

FIG. 20 is a flowchart for explaining a main portion of an example of the inertia torque compensation control by the electronic control device 50, which is repeatedly executed in a predetermined cycle.

First, at step (hereinafter, “step” is omitted) S1, the first electric motor torque Tm1 is calculated that corresponds to an engine torque reaction force to be generated by the first electric motor M1 for the rotation speed control of the engine 12. At 52, it is determined whether a change occurs in the rotation speed of the second electric motor M2. This determination may be made by detecting the actual rotation speed of the second electric motor M2 with a predetermined sensor or made from a target value in the control logic of the second electric motor M2. If the determination at S2 is negative, this routine is accordingly terminated and, if the determination at S2 is positive, the compensation torque ΔTm1 is calculated at S3 for the first electric motor torque Tm1 calculated at S1 for the rotation speed control of the engine 12 so as to reduce an inertia torque generated in the first electric motor M1 in association with a change in rotation speed of the second electric motor M2 at the time of acceleration of a vehicle. At S4, it is determined whether the actual rotation speed Ne of the engine 12 at a time point detected by the engine rotation speed sensor 52 is equal to or greater than the second threshold value N_{TS2} and, if equal to or greater than the second threshold value N_{TS2}, the absolute value of the compensation torque ΔTm1 is compensated to be reduced as compared to the case of less than the threshold value N_{TS2} then this routine is terminated. In the control described above, S3 and S4 correspond to the operation of the inertia torque compensation control portion 72.

FIG. 21 is a flowchart for explaining a main portion of another example of the inertia torque compensation control by the electronic control device 50, which is repeatedly executed in a predetermined cycle. In the control depicted in FIG. 21, the steps in common with the control depicted in FIG. 20 described above are denoted with the same reference numerals and will not be described.

In the control depicted in FIG. 21, following the process at S3 described above, at S5 corresponding to the operation of the engine rotation speed determining portion 74, it is determined whether the absolute value of the actual rotation speed Ne of the engine 12 at a time point detected by the engine rotation speed sensor 52 is less than the predetermined threshold value N_{TS1}. The threshold value N_{TS1} is defined in advance so as not to change the rotation of the engine 12 to negative rotation; if the determination at S5 is positive, this routine is accordingly terminated; and if the determination at S5 is negative, the absolute value of the compensation torque ΔTm1 is compensated to be reduced at S6 corresponding to the operation of the inertia torque compensation control portion 72 and reduced as compared to the ease of less than the threshold value N_{TS1} related to the determination at S5 then this routine is terminated.

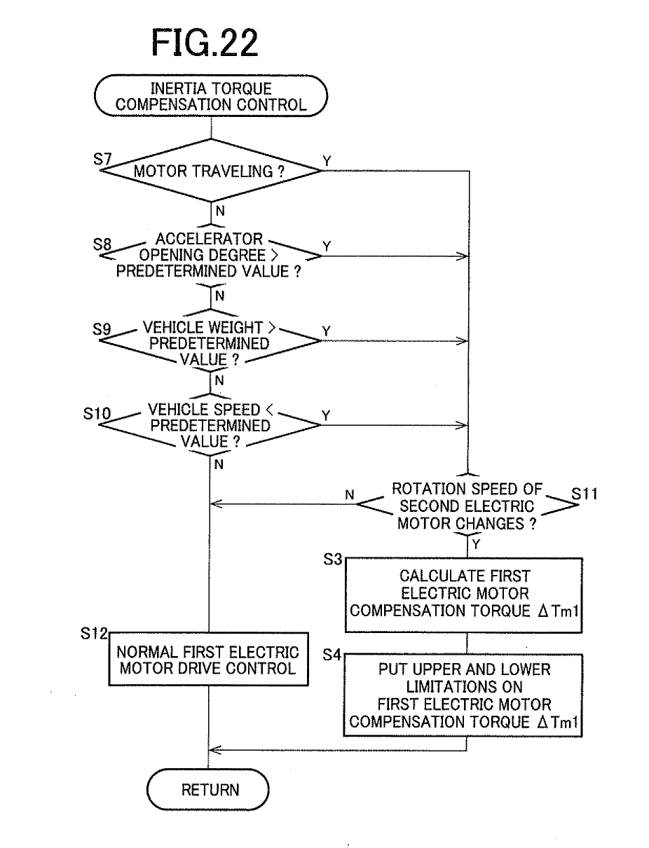

FIG. 22 is a flowchart for explaining a main portion of further example of the inertia torque compensation control by the electronic control device 50, which is repeatedly executed in a predetermined cycle. In the control depicted in FIG. 22, the steps in common with the control depicted in FIG. 20 described above are denoted with the same reference numerals and will not be described.

In the control depicted in FIG. 22, first, at S7 corresponding to the operation of the vehicle start determining portion 82, it is determined whether a vehicle is starting in the motor traveling mode (EV traveling mode). If the determination at S7 is positive, the process from S11 is executed and if the determination at S7 is negative, it is determined at S8 corresponding to the operation of the accelerator opening degree determining portion 80 whether the actual accelerator opening degree Acc at a time point detected by the accelerator opening degree sensor 56 is equal to or greater than the predetermined value A_{TS} defined in advance. If the determination at S8 is positive, the process from S11 is executed and if the determination at S8 is negative, it is determined at S9 corresponding to the operation of the vehicle mass determining portion 78 whether the actual vehicle mass W at a time point detected by the vehicle weight sensor 60 is equal to or greater than the predetermined value W_{TS} defined in advance. If the determination at S9 is positive, the process from S11 is executed and if the determination at S9 is negative, it is determined at S10 corresponding to the operation of the vehicle start determining portion 82 whether a vehicle is starting based on whether the actual vehicle speed V at a time point detected by the vehicle speed sensor 54 is equal to or smaller than the predetermined value defined in advance. If the determination at S10 is positive, the process from S11 is executed and if the determination at S10 is negative, the drive control of the first electric motor M1 for the case of normal control, i.e., for the case of not executing the inertia torque compensation control of this embodiment is executed at S12 and, for example, after the torque of the first electric motor M1 is set to zero, this routine is terminated. At S11, it is determined whether a change occurs in the rotation speed of the second electric motor M2. If the determination at S11 is negative, the process from S12 is executed and if the determination at S11 is positive, the process from S3 described above is executed.

Thus, according to the present embodiment, since the control device executing inertia torque compensation control drives the first electric motor M1 to generate a compensation torque ΔTm1 for reducing an inertia torque Tit generated in the first electric motor M1 in association with a change in rotation speed of the second electric motor M2 at the time of acceleration of a vehicle, the reduction of the power output from the second electric motor M2 can be suppressed to ensure sufficient acceleration performance. Therefore, the control device can be provided that suppresses a decrease in acceleration of the vehicle power transmission device 10, 30 including the electric differential portion 18, 34 at the time of acceleration of a vehicle.

If a rotation speed Ne of the engine 12 is equal to or greater than a predetermined threshold value N_{TS2}, an absolute value of the compensation torque ΔTm1 generated in the inertia torque compensation control is reduced as compared to the case of less than the threshold value N_{TS2}. This can preferably restrain the rotation speed Ne of the engine 12 from increasing more than necessary.

The inertia torque compensation control is executed if a slope angle θ of a road surface on which a vehicle travels is inclined at a predetermined angle θ_{TS} defined in advance or greater. This can ensure sufficient acceleration performance at the time of traveling on a slope road particularly requiring the acceleration performance.

The inertia torque compensation control is executed if a vehicle mass W is equal to or greater than a predetermined value W_{TS} defined in advance. This can ensure sufficient acceleration performance in the case of a relatively heavy vehicle weight particularly requiring the acceleration performance.

The inertia torque compensation control is executed if an accelerator opening degree Ace is equal to or greater than a predetermined value A_{TS} defined in advance. This can ensure sufficient acceleration performance at the time of a driver's accelerating operation (when pressing the accelerator pedal) particularly requiring the acceleration performance.

The inertia torque compensation control is executed at the start of a vehicle. This can ensure sufficient acceleration performance at the start of the vehicle particularly requiring the acceleration performance.

The power transmission device 10 includes an automatic shifting portion 22 disposed at a portion of the power transmission path between the differential portion 18 and the drive wheels 44 and having as a transmitting member 18 an input member coupled to the second electric motor M2, wherein the inertia torque compensation control is executed in accordance with a change in rotation speed of the second electric motor M2 associated with shift of the automatic shifting portion 22. This can ensure sufficient acceleration performance at the time of the shift of the automatic shifting portion 22.

Although the preferred embodiments of the present invention have been described in detail with reference to the drawings, the present invention is not limited thereto and is also implemented in other aspects.

For example, although the inertia torque compensation control portion 72 executes the inertia torque compensation control in the embodiments if positive determination is made by at least one of the road surface slope determining portion 76, the vehicle mass determining portion 78, the accelerator opening degree determining portion 80, and the vehicle start determining portion 82, this is not a limitation of the present invention and, for example, the inertia torque compensation control may be executed on the condition that positive determination is made by both the road surface slope determining portion 76 and the vehicle mass determining portion 78.

The execution conditions of the inertia torque compensation control by the inertia torque compensation control portion 72 are not limited to those described in the embodiments and other conditions may be set in such a way that the control is executed at the time of towing and not executed at the time of non-towing, for example.

Although the embodiments have been described in terms of the form of executing the inertia torque compensation control of the first electric motor M1 solely at the time of the drive control for maintaining the constant rotation speed Ne of the engine 12, the inertia torque compensation control of the present invention may preferably be executed if the rotation speed Ne of the engine 12 varies.

Although the embodiments have been described by examples of applying the present invention to the power transmission device 10 including the automatic shifting portion 22 depicted in FIG. 1 and the power transmission device 30 not including a mechanical shifting portion depicted in FIG. 3, the present invention is also applied to a configuration of the power transmission device 10 depicted in FIG. 1 without the automatic shifting portion 22 or a configuration of the power transmission device 30 depicted in FIG. 3 with a mechanical shifting portion disposed after the output gear 36, for example.

Although not exemplary illustrated one by one, the present invention is implemented with various modifications applied without departing from the spirit thereof.

1.-7. (canceled)

8. A control device for a vehicle power transmission device comprising: an electric differential portion having
a differential mechanism that includes a first rotating element, a second rotating element that functions as an input rotating member coupled to an engine, and a third rotating element that functions as an output rotating member,
a first electric motor coupled to the first rotating element, and
a second electric motor connected to a power transmission path from the third rotating element to drive wheels in a manner enabling power transmission,
the electric differential portion controlling a differential state between a rotation speed of the second rotating element and a rotation speed of the third rotating element by controlling an operation state of the first electric motor,
the control device executing inertia torque compensation control that drives the first electrode motor to generate a compensation torque for reducing an inertia torque generated in the first electric motor in association with a change in rotation speed of the second electric motor at the time of acceleration of a vehicle, and
the inertia torque compensation control being executed at the start of a vehicle.

9. The control device for a vehicle power transmission device of claim 8, wherein if a rotation speed of the engine is equal to or greater than a predetermined threshold value, an absolute value of the compensation torque generated in the inertia torque compensation control is reduced as compared to the case of less than the threshold value.

10. The control device for a vehicle power transmission device of claim 8, wherein the inertia torque compensation control is executed if a slope of a road surface on which a vehicle travels is inclined at a predetermined angle defined in advance or greater.

11. The control device for a vehicle power transmission device of claim 9, wherein the inertia torque compensation control is executed if a slope of a road surface on which a vehicle travels is inclined at a predetermined angle defined in advance or greater.

12. The control device for a vehicle power transmission device of claim 8, wherein the inertia torque compensation control is executed if a vehicle mass is equal to or greater than a predetermined value defined in advance.

13. The control device for a vehicle power transmission device of claim 9, wherein the inertia torque compensation control is executed if a vehicle mass is equal to or greater than a predetermined value defined in advance.

14. The control device for a vehicle power transmission device of claim 10, wherein the inertia torque compensation control is executed if a vehicle mass is equal to or greater than a predetermined value defined in advance.

15. The control device for a vehicle power transmission device of claim 11, wherein the inertia torque compensation control is executed if a vehicle mass is equal to or greater than a predetermined value defined in advance.

16. The control device for a vehicle power transmission device of claim 8, wherein the inertia torque compensation control is executed if an accelerator opening degree is equal to or greater than a predetermined value defined in advance.

17. The control device for a vehicle power transmission device of claim 9, wherein the inertia torque compensation control is executed if an accelerator opening degree is equal to or greater than a predetermined value defined in advance.

18. The control device for a vehicle power transmission device of claim 10, wherein the inertia torque compensation control is executed if an accelerator opening degree is equal to or greater than a predetermined value defined in advance.

19. The control device for a vehicle power transmission device of claim 11, wherein the inertia torque compensation control is executed if an accelerator opening degree is equal to or greater than a predetermined value defined in advance.

20. The control device for a vehicle power transmission device of claim 12, wherein the inertia torque compensation control is executed if an accelerator opening degree is equal to or greater than a predetermined value defined in advance.

21. The control device for a vehicle power transmission device of claim 13, wherein the inertia torque compensation control is executed if an accelerator opening degree is equal to or greater than a predetermined value defined in advance.

22. The control device for a vehicle power transmission device of claim 14, wherein the inertia torque compensation control is executed if an accelerator opening degree is equal to or greater than a predetermined value defined in advance.

23. The control device for a vehicle power transmission device of claim 15, wherein the inertia torque compensation control is executed if an accelerator opening degree is equal to or greater than a predetermined value defined in advance.

24. The control device for a vehicle power transmission device of claim 8, comprising a mechanical shifting portion disposed at a portion of the power transmission path between the differential portion and the drive wheels and having an input member coupled to the second electric motor, wherein the inertia torque compensation control is executed in accordance with a change in rotation speed of the second electric motor associated with shift of the mechanical shifting portion.

25. The control device for a vehicle power transmission device of claim 9, comprising a mechanical shifting portion disposed at a portion of the power transmission path between the differential portion and the drive wheels and having an input member coupled to the second electric motor, wherein the inertia torque compensation control is executed in accordance with a change in rotation speed of the second electric motor associated with shift of the mechanical shifting portion.

26. The control device for a vehicle power transmission device of claim 10, comprising a mechanical shifting portion disposed at a portion of the power transmission path between the differential portion and the drive wheels and having an input member coupled to the second electric motor, wherein the inertia torque compensation control is executed in accordance with a change in rotation speed of the second electric motor associated with shift of the mechanical shifting portion.

27. The control device for a vehicle power transmission device of claim 11, comprising a mechanical shifting portion disposed at a portion of the power transmission path between the differential portion and the drive wheels and having an input member coupled to the second electric motor, wherein the inertia torque compensation control is executed in accordance with a change in rotation speed of the second electric motor associated with shift of the mechanical shifting portion.
